(19) United States
(12) Patent Application Publication
(10) Pub. No.: US 2005/0235415 A1
(43) Pub. Date: Oct. 27, 2005

(54) Aid for turning bedridden persons

(75) Inventors: Heine Buus Pedersen, Aalborg (DK); Flemming Buus Pedersen, Nibe (DK)

Correspondence Address: James C Wray, Suite 300, 1493 Chain Bridge Road, McLean, VA, 22101, US

(73) Assignee: H>C> Equipment ApS

(21) Appl. No.: 10/528,359

(22) PCT Filed: Sep. 18, 2003
(86) PCT No.: PCT/DK03/00601

§ 371 Date: Apr. 11, 2005

(30) Foreign Application Priority Data
Sep. 20, 2002 (DK) PA200201387

(51) Int. Cl. A61G 7/10

(52) U.S. Cl. 5/81.1 R

(57) ABSTRACT

Considerable force and tiring work by about five orderlies/nurses is required to turn surgery patients, who are often anaesthetised or have reduced mobility. The turning also requires disconnecting measuring and monitoring equipment connected to the patient, which takes much time. An aid for turning persons lying on a bed, particularly an operating table, solves the above problems. The aid includes a rotatable roller oriented in parallel with and capable of being suspended at a long side of a bed, where the rotational axis of the roller is capable of being elevated above the resting surface of the bed as the ends of the roller are suspended at free ends of upright brackets releasably attached at the long side of the bed. hereby, one orderly/nurse is made redundant, and furthermore it will not be necessary during the turning to disconnect and reconnect possible apparatuses connected to the patient.

### BACKGROUND OF THE INVENTION

The present invention concerns an aid for turning persons lying on a bed. Such an aid can find application in many different places, but particularly within the health sector such an aid may be very relevant. The aid will particularly find application on an operation table or a bed on which persons lying in preferably horizontal position are to be turned.

In connection with surgery, it will often be necessary to perform turning of the patient while he is anaesthetised. E.g. by surgery of the back, the patient is anaesthetised after which the patient is turned to lie flat on the stomach. By large back surgery where access to the back typically occurs via the stomach region, the patient is returned to supine position. Other operations occur by the patient being laid in lateral position after anaesthetisation has been performed, and also here there is need for complete or partial turning of the anaesthetised patient.

Doing the work of turning patients, they being anaesthetised patients or patients that are disabled for different reasons, is a very straining work for orderlies or nursing staff who are to do this, as the turning of the person implies lifting in a definitely inconvenient work position, and ailments of the back due to many years of working as orderly or nurse are also well-known.

Of course, many different lifting techniques and bed making methods have caused that these procedures are done in a more suitable way for the staff performing it. However, this still leaves the problem with performing pull and lift of heavy burdens in inconvenient work positions. Particularly the work of turning anaesthetised patients on operation tables is a very heavy and demanding work, as the anaesthetised person is not at all capable of assisting in the turning. The manual work in that connection for turning just one person requires the effort of eight persons, where all provide a not insignificant effort for performing the turning. In that connection is to be noted that the anaesthetised patient is not just to be turned, but simultaneously with the turning, the patient is to be controlled so that he is not suffering any harm during the turning. By making turnings, it is often necessary to disconnect different monitoring equipment etc. that has been connected to the patient, which sometimes can imply a certain safety hazard for the patient.

Also in connection with usual care of bedridden persons, including particularly elderly people, turning of the patient also make demands on physical ability on the part of the nursing staff. E.g. by washing the person it is necessary to turn the bedridden person in the bed, as well as in connection with a lot of other tasks it is necessary to attend to the person from several sides. This typically implies that the caretaker has to get hold of the bedridden person physically and to push/pull/roll the person from one side to the other. This work implies many drawbacks for the bedridden person and for the nursing staff. Bedridden persons requiring care are physically weak, either due to sickness or as a consequence of old age, or a combination of these two factors. Therefore, it will be a physical strain for these persons to be manipulated/turned by the nursing staff who in that connection have to get hold of and pull in the person physically for turning him.

Concurrently with the rising number of bedridden elderly people and cuts in the nursing area and the hospital area, there will be fewer nurses and orderlies to take care of more patients/elderly people. A large part of these patients and elderly are bedridden for shorter or longer periods, making special demands on the nursing staff. At the same time, for reducing the work environmental load of orderlies/nursing staff with regard to the backs and shoulders of the latter, it will be necessary that more orderlies/nurses etc. than used hitherto are cooperating for turning a bedridden person or an anaesthetised person on an operating table. Hence, there are oppositely directed developments that seem almost incompatible.

Thus there is need for a solution that may be a help for orderlies who have to perform the very heavy and straining work in connection with turning anaesthetised patients on an operation table or in connection with turning bedridden patients. The present invention provides for this need with an aid for use in turning lying persons on a bed, e.g. an operating table, and the aid is peculiar in including a rotatable roller oriented in parallel with and capable of being suspended at a long side of a bed or the underframe of the bed, where the rotational axis of the roller is capable of being elevated above the resting surface of the bed, as the ends of the roller are suspended at free ends of, upright brackets releasably attached at the long side of the bed.

The aid enables that a sheet or a sterile underlay laid upon a bed may be attached to the roller at one edge side of the sheet being rolled up around the roller by rotation of the same, whereby the sheet is fastened to the roller by simple rolling up on the surface of the roller. By continued rolling up of the sheet by rotation of the roller about its rotational axis, a person lying of the sheet or the sterile underlay fastened to the roller will be forced to rolling and thereby be turned. The disposition of the roller above the resting surface of the bed implies that by rotation of the roller at one time is exerted a lateral and obliquely upwards directed pull in the sheet, implying that the person to be turned, lying on the sheet, is pulled towards the aid, and the person will be forced to a rolling movement, the closer the point of contact between person, sheet and bed approaches the roller, as well as the inclination of the sheet or underlay will become steeper, eventually causing rolling of the person. The advantage is hence that persons assisting in turning the patient, and who previously by performing this work were to exert the pull in the side of the sheet, partly with a lateral pull and partly an obliquely upwards directed pull simultaneously with the patient was to be supported during the rolling, now can concentrate completely on supporting the patient during the rolling, as the forceful work itself is now taken over by the aid according to the invention.

The aid may at its free ends be suspended on the free ends of the upright brackets by means of slide bushings, and the aid may advantageously include at one end an electric gearmotor which with a special fitting is fastened to the free end of one of the brackets standing up at the long side of the bed. The electric gearmotor naturally facilitates turning the patient for the staff performing the turning, but in that connection it is to be mentioned that the aid according to the invention in a more simple version may be provided with a crank handle that also may find application at places where the access to electricity is limited or even non-existing. This condition will, however, imply that a person is to perform the turning of the roller, but all taken together the work with turning the patient will be significantly eased as the other staff may entirely concentrate on supporting and helping the patient during the turning.

The space around an operating table or a sickbed during turning a lying person, is normally very restricted, as several orderlies and nurses assisting with the turning are disposed around the bed.

With the purpose of minimising the space consumption of the aid in this work intensive area, electric gearmotors may be of the kind provided inside the cavity of the roller so that the drive shaft of the gearmotor is connected with the roller by a carrier bolt inserted through a hole in the wall of the roller. Hereby, the gearmotor itself will in no way take up any of the already scarce space around the operating table, and thus be interfering with the persons standing around the bed in connection with turning the patient lying on it.

With regard to perform control of the operation of the aid, to be precise the operation of the gearmotor, from the most advantageous position during turning of the patient, the electric motor of the gearmotor may be connected with a control unit for activating and deactivating of the gearmotor, the control unit also including a handheld operating panel of known type connected thereto via a suitable communication interface (often constituted by a cable connection with spiral coilings). Hereby is achieved a high degree of flexibility and mobility for the person controlling the aid during turning the person on the operating table.

The electric motor of the gearmotor may advantageously be constituted by a stepmotor, whereby return run of the roller when the motor is not activated is counteracted.

As already indicated, the aid may be disposed on a long side of a bed or its underframe so that the roller is oriented in parallel with the bed. In that connection it is to be mentioned that a real permanent mounting of the aid at/on the bedside or on its underframe is inexpedient. Therefore, it is preferred that the aid is adapted so that there is provided possibility of rapid and efficient releasable attachment to the said side of the bed or its underframe in connection with using the aid. The brackets of the aid may thus advantageously be constituted by angular fittings having legs with holding means disposed opposite to the free ends for releasable attaching of brackets and thereby the aid at the long side of a bed or its underframe, where the holder means are adapted and interacting with the long side of the bed or its underframe so that the brackets and the roller are capable of absorbing forces oriented transversely and obliquely upwards relative to the resting surface of the bed. In that connection may be noted that the aid may advantageously include interacting sliding guideways for mounting at the bed side. Hereby may be achieved the advantage that the holding means of the aid only need to be designed as to interact with the said sliding guideway, so we are speaking of a kind of standardisation of the fastening between the holding means of the aid and the bed at which the aid is to be applied.

The said standardisation may furthermore have the advantage that it may be ensured that the holding means and the sliding guideways are interacting so that the free ends of the brackets on which the roller is suspended are pivotable within an acute angle in relation to the vertical. The pivoting of the aid from the acute angle and until vertical will typically take place at the moment in which the patient is drawn out from one side of the bed, and where the rolling of the patient has been initiated, where there is need for an almost vertical pull in the sheet for ensuring rolling of the patient.

With the object of ensuring a fast, but efficient attachment between underlay/sheet and the aid according to the invention, the surface of the roller may be provided with one half of a self-adhesive Velcro® tape for releasable attachment of a side edge of a sheet or cloth laid on the bed, where the said side edge of the sheet or the cloth includes fastening means interacting with the Velcro® tape, e.g. in the form of a ribbon that has been sewn on. Hereby is achieved the advantage that the edge of the underlay may be fastened effectively to the roller with an easy move, after which the turning of the patient can be commenced by activating electric gearmotors during the rolling up of the underlay onto the roller.

It is to be mentioned that the apparatus of course can be used at both sides of the bed, if only the sliding guideways needed for the holding means have been mounted at the bed sides.

With the purpose of utilising the aid according to the invention most efficiently, and to even make superfluous mounting of the said sliding guideways at the side edges of the bed, the aid according to the invention may be mounted in portable form on a trolley that include a carrier rail for releasable fastening of the aid. Hereby is achieved the advantage that the aid may be transported between different beds on which it is operated by persons with the need for being turned. Thus it will be easy to move the aid from the trolley and onto a sliding guideway mounted on the bed, after which the turning of the person is performed, and subsequently the aid is replaced on the carrier rail of the trolley for transport to a new task.

In that connection, the trolley may furthermore include the control unit, e.g. as the handheld operating panel connected therewith, and in case that the aid is to be used at localities where there is no suited power source for connection to and operation of the gearmotor, the trolley may also include a rechargeable power supply.

In case that the aid is to be used for turning persons on beds that do not include sliding guideways, the trolley may be utilised in the same way as if it was mounted on the bed or its underframe, as the trolley is disposed in such a way at the side of the bed with undercarriage of the trolley in contact with the side edge of the bed, and where the underlay is attached to the roller as previously described, after which the roller is activated by means of the operating panel, and the turning of the patient is done in the same way as previously described.

However, in that connection it is to be mentioned that the trolley by its presence at the bedside takes up some of the scarce space at the side of an operating table to the inconvenience of the persons that are to help and support the patient during the turning.

However, as the use of the aid during the accomplishment of the turning implies that the number of orderlies/nurses assisting in turning the patient on the operation table is reduced, in that way is compensated for the space occupied by the trolley.

With the purpose of using the aid when this is placed on the trolley in connection with turning persons disposed on tables at different levels, the trolley may be adapted so that the height of the carrier rail is adjustable. This may possibly be realised by the adapting the trolley legs so that they are adjustable in height.

In other embodiments of the invention, the aid may be envisaged as being mounted permanently on the table, so that this is collapsible to passive position when not in use, so that the aid is not interfering with the access to the bed from the sides.

By the aid according to the invention there is thus provided a solution for a work environmental problem for the orderlies/nurses that usually perform turning of lying patients on operating table and other beds, as the more forceful part of the work with turning a patient is performed by the aid, whereby the number of persons engaged with turning a patient may be reduced by one orderly/nurse. Furthermore, an additional advantage is achieved that since the persons assisting in turning the patient may more concentrate in supporting and helping the patient during the turning procedure instead of exerting lift and pull at inconvenient work positions, and thus by using the aid there may be performed turning of a patient without any instruments etc. connected to the patient having to be disconnected during the turning, with consequent greater safety for the patient and savings in time used by orderlies and nursing staff in connection with connecting and disconnecting. In all, not a small additional advantage by the aid according to the invention.

### DESCRIPTION OF THE DRAWING

The invention is explained subsequently with reference to the drawing, where:

FIG. 1 is an exploded view of an aid according to the invention for turning lying persons,

FIG. 2 shows the same as FIG. 1, but where the aid is assembled and mounted at a bedside,

FIG. 3 shows a control unit with associated power supply and operating panel and suspension therefor in separated form, and

FIG. 4 shows the elements indicated in FIG. 3 in assembled condition.

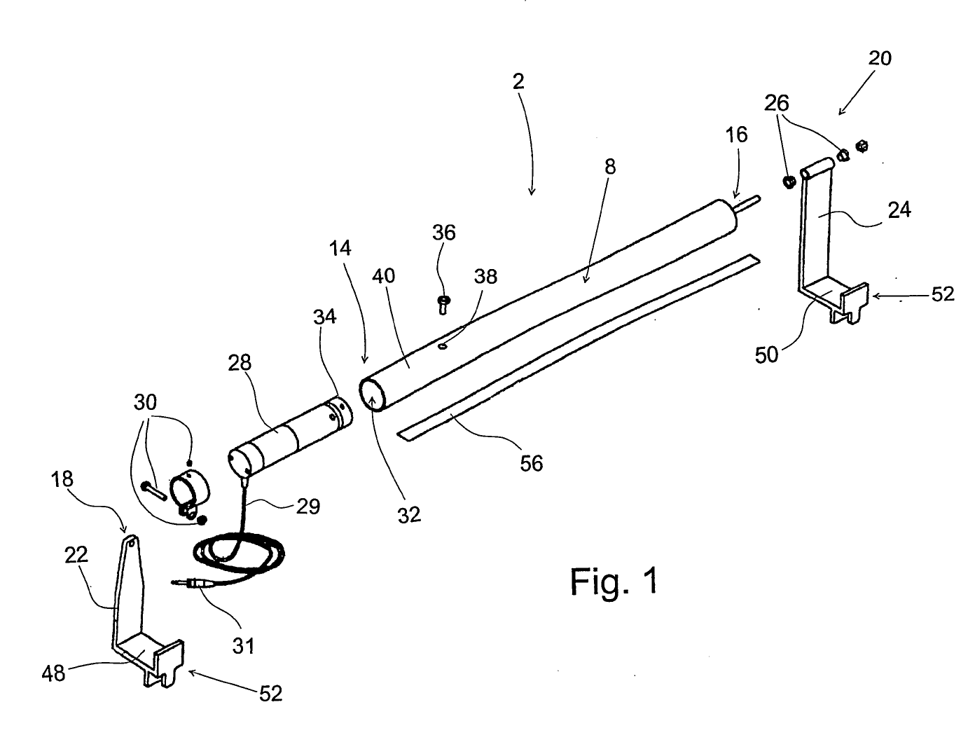

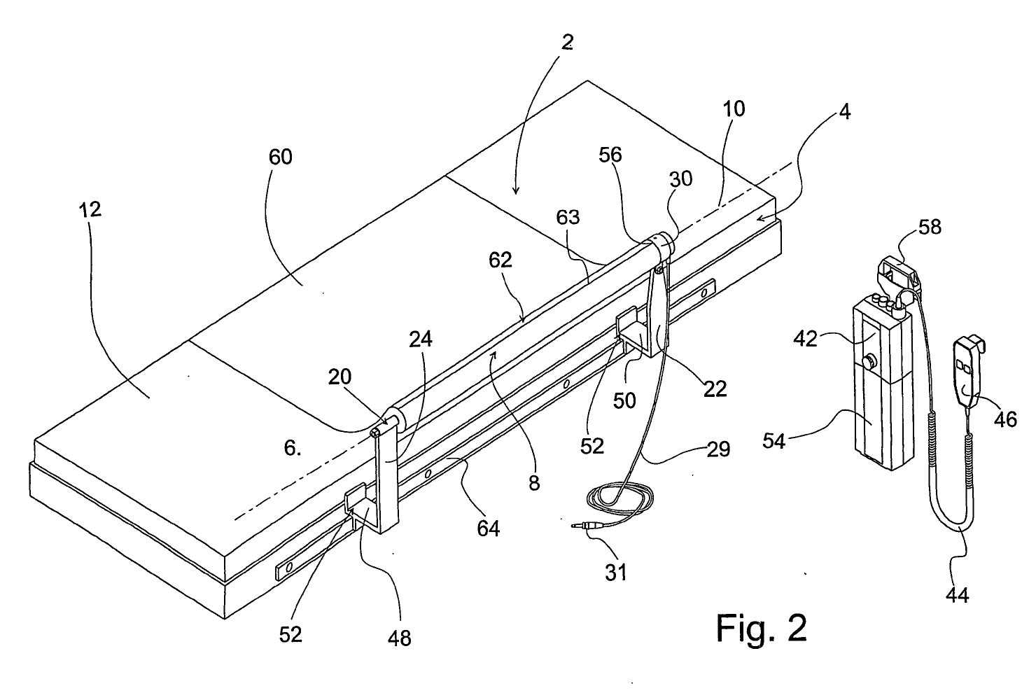

FIG. 1 shows an exploded perspective view of an embodiment of an aid 2 according to the invention for turning persons lying on a bed 6, cf. FIG. 2. Below is referred to FIG. 1 as well as to FIG. 2.

The aid 2 includes a roller 8 with a first end 14 and a second end 16, the roller 8 being journalled at the second end 16 by means of an axle pin and slide bushings 26 to the free end 20 of a bracket 24 constituted by an angular fitting, where at the angular leg 50 there is provided holding means 52 for fastening to the long side 4 of a bed 6.

The front end 14 includes a cavity 32 in which is accommodated a gearmotor 28 having its drive shaft 34 connected to the roller 8 with a carrier bolt 36 which is received in a hole 38 in the wall 40 of roller. The gearmotor 28, in the mounted position, cf. FIG. 2, is bluntly projecting from the roller end 14 and fastened in a holder fitting 30 mounted in the free end 18 of a bracket 22 that is constituted by an angular fitting, the angular legs 48 of which include holding means 52 at their free ends for securing the bracket 22.

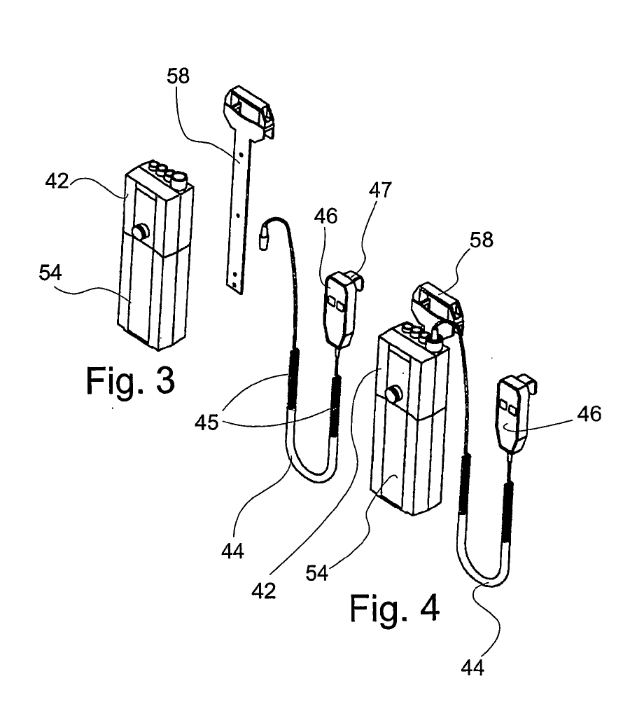

The gearmotor 28, which is supposed to be used in the shown embodiment, includes a cable connection 29 with a plug 31 for connecting to a control unit 42, cf. FIGS. 3 and 4, which in the shown embodiment include a power supply, possibly in the shape of a rechargeable battery, and to which control unit 42 there is connected an operating panel 46 via a wire connection 44, which has be made with spiral coilings 45 for providing the user with the greatest possible flexibility and mobility and freedom in movement in connection with operating the aid 2. The control unit of the gearmotor 28 may be adapted so that two gearmotors controlled from the operating panel 46 via the wire 44 may be connected thereto. The control unit 42 for the gearmotor 28 is provided with a suspension 58, and the operating panel 46 also includes a suspension hook 47 at the rear side. The wire 44 includes, as shown in FIGS. 3 and 4, two spirally coiled lengths 45 providing that the wire 44 is kept off floors as well as simultaneously providing a considerable flexibility regarding the position of the user of the operating panel in relation to the control unit 42. The wire 44 may in another embodiment be spirally coiled over its entire length.

In the shown embodiment, a section with Velcro® tape 56 has been bonded to the outer side of the roller 8.

In FIG. 2, the aid 2 is shown mounted on a sliding guideway 64 with the roller 8 oriented in parallel with the long side 4 of a bed/operating table. As it appears, a sheet 60 is laid upon the resting face 12 of the bed 6, where the side edge 63 of the sheet is provided with a Velcro® ribbon 62 interacting with the self-adhering Velcro-tape 56 on the roller 8. As it further appears, the sheet 60 is releasably fastened at the Velcro® ribbon 62 to the surface of the roller 8, and the aid 2 is thus made ready for turning a person (not shown) lying on the sheet by activating the gearmotor 28 at the operating panel 46.

By activating the gearmotor 28, the sheet 60 is rolled up around the roller 8, causing the person lying on the sheet 60 to be pulled closer to the axis of rotation 10 of the roller, whereby the sheet 60 under the person will be subjected to an obliquely upward pull transverse of the bed 6, causing the person to be subjected to a rolling movement which strongly contributes to facilitating the work with turning the person, as the staff assisting by the turning procedure is only to ensure that the person is supported and assisted in the turning.

By the aid 2 according to the invention there is provided a particularly efficient and very usable tool for use in turning patients lying on operating tables and the like, and where the aid, if distributed to hospitals, old people's homes, and in the health sector in general, will decidedly have a preventive action on the number of registered ailments of the back of orderlies and nursing staff. The inventor has, of course, realised that the aid according to the invention may assume other forms than those specified in the drawing and as described above.

E.g. the aid 2, the roller 8 including control unit 42, operating panel 46 and wire 44 between control unit and operating panel, and possibly a power source 54 for the gearmotor 28 may be arranged on a separate unit that include wheels for transporting the unit and actuators for level control of the roller 8. Furthermore, in this embodiment, the aid may be adapted so that the brackets 22, 24 are arranged for mutual uniform longitudinal telescopic adjustment. This embodiment provides that the aid may be be disposed at a long side of an operating table without the brackets being fastened directly to the long side or the underframe of the operating table, but may only remain on the separate wheel-borne unit, the undercarriage of which is brought into contact with the long side of the operating table, which will be sufficient for stabilising the aid/roller, so that the pull in the sheet may be performed in the same way as described above in connection with turning a patient lying on the operating table.

### REFERENCE NUMBERS

2: aid
4: long side
6: bed or table
8: roller
10: rotational axis for 8
12: resting face of bed 6
14: first end of roller 8
16: second end of roller 8
18: free end of bracket 22
20: free end of bracket 24
22: bracket
24: bracket
26: slide bushings
28: gearmotor
29: electric connection for gearmotor 28
30: fitting for gearmotor 28
31: plug on electric connection 29
32: cavity in roller 8
34: drive shaft for gearmotor
36: carrier bolt
38: hole in roller wall
40: roller wall
42: control unit for gearmotor 28
44: wire between control unit 40 and operating panel 46
45: spiral coiling on wire 44
46: operating panel
47: suspension panel on operating panel 46
48: bracket leg 22
50: bracket leg 24
52: holding means for fastening brackets 22, 24
54: power source (possibly rechargeable battery)
56: self-adhesive Velcro-tape on surface of roller 8
58: suspension for control unit 42 and power source 54
60: sheet
62: Velcro® tape at side edge 63 of sheet
63: side edge of sheet
64: sliding guideway

1. Aid (2) for turning persons lying on a bed (6), particularly persons lying on an operation table (6), characterised in that the aid includes a rotatable roller (8) oriented in parallel with and capable of being suspended at a long side (4) of a bed (6) or the underframe of the bed (6), where the rotational axis (10) of the roller (8) is capable of being elevated above the resting surface (12) of the bed (6), as the ends (14, 16) of the roller (8) are suspended at free ends (18, 20) of, upright brackets (22, 24) releasably attached at the long side (4) of the bed.

2. Aid according to claim 1, characterised in that an electric gearmotor (28) is provided at least at one end (14) of the roller (8) for rotation of the roller around its rotational axis (10), and that the motor (28) is fastened to the free end (18) of the bracket (22) with a fitting (30).

3. Aid according to claim 1, characterised in that the gearmotor (28) is disposed inside a cavity (32) in the roller (8), so that the drive shaft (34) of the gearmotor is connected with the roller (8) by a carrier bolt (36) inserted through a hole (38) in the wall (40) of the roller.

4. Aid according to claim 1, characterised in that the electric motor is connected to a control unit (42) associated with the aid for activating and deactivating the gearmotor (28), the control unit (42) also including a handheld operating panel (44) connected thereto via a communication interface (34).

5. Aid according to claim 1, characterised in that the electric motor of the gearmotor is constituted by a step motor.

6. Aid according to claim 1, characterised in that the brackets (22, 24) are constituted by angular fittings having legs (46, 48) with holding means (50) disposed opposite to the free ends (18, 20) for releasable attaching of brackets (22, 24) and thereby the aid (2) at the long side (4) of a bed (6) or its underframe, in that the holder means (50) are adapted and interacting with the long side (4) of the bed (6) or its underframe so that the brackets (22, 24) and the roller (8) are capable of absorbing forces oriented transversely and obliquely upwards relative to the resting surface (12) of the bed.

7. Aid according to claim 6, characterised in that the holder means (50) are adapted and interacting with the long side (4) of a bed (6) or its underframe so that the free ends (18, 20) of the brackets (22, 24) are pivoting within an acute angle (V) in relation to vertical.

8. Aid according to claim 1, characterised in that the roller surface has been provided with means for securing a sheet, and that the means may include a rubber coating on the surface of the roller, Velcro@, or other commonly known mechanical fastening.

9. Aid according to claim 1, characterised in that the roller (8) with associated brackets (22, 24), control unit (42), operating panel (46), wire between control unit (42) and operating panel (46), and possibly a power source (54), are arranged on a separate unit that include wheels for transporting the unit, actuators for level control of the roller (8), and that the brackets (22, 24) are arranged for mutual uniform longitudinal telescopic adjustment.

10. Bed (6) including sliding guideways interacting with holding means (50), where an aid (2) according to claim 1 is mounted on a long side (4) of the bed (6) or its underframe, and where on the surface of the bed there is laid a sheet, one side of which being fastened to the roller (8) by rolling up around it, and where the sheet is displaceable in the transverse direction of the bed by activation of the gearmotor (28) so that the sheet is rolled up on the roller (8).

11. Bed (6) arranged with an aid (2) according to claim 9 at the side of the bed, and where on the surface of the bed there is laid a sheet having one side fastened to the roller (8) by rolling up around it, and where the sheet is displaceable in the transverse direction of the bed by activating the gearmotor (28) so that the sheet is rolled up on the roller (8).
